(19) United States
(12) Patent Application Publication
(10) Pub. No.: US 2013/0236616 A1
(43) Pub. Date: Sep. 12, 2013

(54) METHOD OF SCAVENGING OXYGEN AND ABSORBING OXYGEN

(71) Applicant: Thomas William Beckenhauer, Puyallup, WA (US)

(72) Inventor: Thomas William Beckenhauer, Puyallup, WA (US)

(21) Appl. No.: 13/261,655

(22) PCT Filed: Nov. 16, 2011
(86) PCT No.: PCT/US11/01909

§ 371 Date: May 6, 2013

Related U.S. Application Data
(60) Provisional application No. 61/458,059, filed on Nov. 17, 2010.

(51) Int. Cl. C09K 15/06; A23L 3/3454; B01D 53/14

(52) U.S. Cl. CPC C09K 15/06; B01D 53/14; A23L 3/3454
USPC 426/330.2; 95/241; 426/330.5; 426/330.3; 426/330.4; 426/330; 426/321; 95/138

(57) ABSTRACT

Methods of absorbing oxygen are disclosed with the use of compositions useful as oxygen absorbers. The compositions are generally salts of unsaturated fatty acids that have one or more carbon to carbon double and or triple bonds. The compositions may be prepared by reacting an unsaturated fatty acid with a hydroxide resulting in a salt of the unsaturated fatty acid. Water soluble compositions are dissolved in aqueous solutions for the purpose of absorbing oxygen from the aqueous solutions and or their containers. Water insoluble compositions are protected from moisture due to their water repellent character and this characteristic is used advantageously in order to absorb oxygen from containers that may contain moisture where it is desired that the compositions remain relatively unaffected by moisture, intact and remain where they are placed.

### TECHNICAL FIELD

The present invention relates generally to compositions useful in scavenging and absorbing oxygen and, more specifically, to compositions formed from the combination of unsaturated fatty acids and compounds containing cations. The resultant compounds thus contain a positive cation portion and a negative anion portion and are generally regarded as salts. The anion portion contains one or more unsaturated carbon to carbon double and or triple unsaturated bonds. Some iterations of the compositions are water soluble and as such are useful in absorbing oxygen from aqueous solutions and or their containers. Other iterations of the compositions are effectively water insoluble, somewhat water repellent and therefore useful in circumstances wherein it is desired to keep the compositions contiguous and in place. Water insoluble compositions once placed may absorb oxygen from their containers. The present invention also pertains to methods relating to the aforementioned compositions.

### BACKGROUND ART

Oxygen absorbers and oxygen scavengers have typically involved the use of oxidizable, elemental iron. When introduced into confined spaces, pure or relatively pure iron tends to oxidize the available oxygen in those confined spaces such that the level of oxygen is lowered or theoretically eliminated.

Advantages of reduced oxygen include, but are not limited to reduction of unwanted aerobic organisms such as bacteria, or other deleterious microbes. Another advantage is that the reduction of oxygen can reduce or prevent corrosion of oxidizable metals.

A disadvantage of the prior art is that the elemental iron or iron filings need to be contained within a packet. Such packets present a choking hazard when used in food, pharmaceutical and neutraceutical applications. They also must be affixed within their containers above any powdered product so that they are within reach of the atmosphere that is intended to be deoxygenated. Otherwise, if they are covered by products such as powders, they are ineffective in reducing the oxygen content within such atmospheres.

A further disadvantage of iron oxygen absorbers and iron oxygen scavengers is that they are not water soluble and as such are not effective within aqueous environments. Within an aqueous environment iron oxidizes and causes deleterious and unsightly rust and rust stains.

### DISCLOSURE OF INVENTION

The present invention generally relates to a method or methods of scavenging or absorbing oxygen and removing it from spaces and situations wherein it may otherwise be detrimental.

In one embodiment, the compositions used in the method to scavenge oxygen are the result of the chemical combination of a cation and an anion. Either or both the cation and anion has at least one unsaturated carbon to carbon double and or triple bond. Unsaturated carbon to carbon double and or triple bonds have the capacity to draw oxygen from their environment and bind it to the compositions useful as oxygen absorbers that have the carbon to carbon double and or triple bonds. As such, the unsaturated carbon to carbon double and or triple bonds scavenge or absorb oxygen. For purposes of definition only, an example of an unsaturated carbon to carbon double bond is exemplified in the compound ethylene. The bond between the two carbon atoms in ethylene is an unsaturated carbon to carbon double bond as described herein. Again, ethylene is used as an example only for the purposes of definition of an unsaturated carbon to carbon double bond. The following is a representation of ethylene and its carbon to carbon double bond:

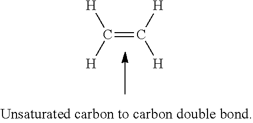

In another embodiment, the cation is any alkali metal cation with a net ⁺1 charge and the anion has at least one unsaturated carbon to carbon double and or triple bond.

In another embodiment, the cation is any alkali metal cation with a net ⁺1 charge. The anion may originate from any organic acid that has at least one unsaturated carbon to carbon double and or triple bond. The hydrogen from the hydroxyl portion of the carboxyl group within the organic acid is necessarily ionized to form the anion and the anion then reacts with the cation to form a composition suitable for the oxygen scavenging purposes of the present invention as they relate to water soluble compositions as represented by the following:

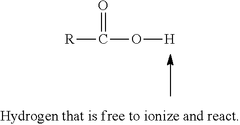

In another embodiment, the cation is any alkali metal cation with a net ⁺1 charge and the anion is any organic acid that is capable of ionizing to produce an anion with a net charge of ⁻1, ⁻2, ⁻3, ⁻4 or greater and having at least one unsaturated carbon to carbon double and or triple bond. The organic acid anion with a net charge of ⁻1, ⁻2, ⁻3, ⁻4 or greater could be, for example, a dicarboxylic acid that has at least one unsaturated carbon to carbon double and or triple, bond.

In general, the resultant composition used in the method of the present invention is water soluble enough to suit the oxygen scavenging purposes of the present invention within aqueous solutions and or their containers. To be water soluble enough to suit the oxygen scavenging purposes of the present invention a resultant composition would need to be water soluble enough to yield a concentration that sufficiently scavenges enough oxygen to prevent detriment by oxygen to said solution. For example, that is accomplished when the resultant composition is generally a salt that could be the result of the reaction between an alkali metal hydroxide and an organic acid that contains at least one unsaturated carbon to carbon double and or triple bond.

The cation involved in the composition of the method of the present invention could also be a non alkali metal anion such as the ammonium ion (NH₄OH)⁺¹. The cation involved could also be a polyatomic cation such as the ammonium ion (NH₄OH)⁺¹.

In general, the resultant compositions need to be water soluble enough to suit the oxygen scavenging purposes of the present invention within aqueous solutions and or their containers and be able to react with and thereby scavenge oxygen. For example, a composition would accurately reflect the present invention if the cation has a net charge of ⁺1, ⁺2, ⁺3, ⁺4 or greater, but still yields a composition that is water soluble enough to suit the oxygen scavenging purposes of the present invention within aqueous solutions and or their containers, and that contains an anion with at least one unsaturated carbon to carbon double and or triple bond capable of scavenging oxygen.

The anion could contain one or more unsaturated carbon to carbon triple bonds. For purposes of definition only, an example of an unsaturated carbon to carbon triple bond can be found in the compound acetylene where the bond between the two carbon atoms is an unsaturated carbon to carbon triple bond. Again, acetylene is only an example for the purposes of definition of an unsaturated carbon to carbon triple bond. Acetylene and its unsaturated carbon to carbon triple bond are represented by the following:

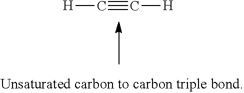

There are two major generalities of the present invention. In one embodiment there is an iteration of the invention that results in compositions that are water soluble enough to suit the oxygen scavenging purposes of the invention within aqueous solutions. In another embodiment of the present invention all of the previous descriptions apply except that the resultant composition or compositions are not appreciably soluble in water. So to clarify, there is one general embodiment wherein the compositions involved are water soluble enough to suit the oxygen scavenging purposes of the invention in aqueous media, and a second separate general embodiment wherein the compositions involved are not water soluble enough to suit the oxygen scavenging purposes of the invention in an aqueous medium. The compositions useful as oxygen absorbers that are not appreciably water soluble are useful in applications where moisture is present and it is desirable to have a composition that stays intact and in place when in the presence of moisture.

### BEST MODE FOR CARRYING OUT THE INVENTION

The following is an example of the best mode for carrying out the invention and the process of making and using the present invention. Equal molar quantities of sodium hydroxide and linolenic acid are reacted in an aqueous solution. The procedure is listed below in order of addition:

While stirring, in a two liter beaker, combine:

| | |
|---|---|
| 681.57 | grams of water |
| 40.00 | grams of sodium hydroxide |
| 278.43 | grams of linolenic acid |
| 1000.00 | grams total |

Continue to stir and heat to 190° F. until a solution of dissolved sodium salt of linolenic acid is formed. The resultant sodium salt of linolenic acid is an example of the best mode of forming compositions useful as oxygen absorbers within aqueous solutions as disclosed in the present invention. The composition is then dissolved into an aqueous medium for the purpose of absorbing oxygen from the aqueous medium and or its container.

Similarly, calcium hydroxide could be reacted with linolenic acid in the formation of compositions useful as oxygen absorbers. The resultant composition would not be appreciably soluble in water and as such could be used in applications where moisture is present and it is desirable to have a composition that stays intact and in place when in the presence of moisture.

### INDUSTRIAL APPLICABILITY

Once the appropriate composition or compositions have been formed, the method of the present invention may be applied in accordance with the following means.

The following is a discussion of the methods of using water soluble versions of the present invention. A water soluble version of the composition may be dissolved in aqueous food products for the purpose of scavenging oxygen. An amount of the water soluble versions would be dissolved in various aqueous media in sufficient quantities to prevent or reduce the detrimental effects of oxygen. The following is a list that may reflect some examples of aqueous products that could benefit from the present invention, but is in no way proposed to be a comprehensive list: milk products, soups, coffee drinks, canned goods, fruit juices, beer, wine, sport drinks, energy drinks, spaghetti sauce, apple sauce, olives, barbeque sauce, teriyaki sauce, canned fish, canned meats, teas, gravies, jams, jellies, preserves, syrups, honey, catsup, mustard, mayonnaise, steak sauce, pickles, relish, aqueous condiments, and in general any aqueous food product kept inside any container. Non food aqueous solutions include but are not limited to the following: industrial or mechanical equipment, boiler systems, engine cooling systems, steam heating systems, medical or dental equipment, refrigeration or air conditioning equipment, any form of equipment that is heated and or cooled by water, fire sprinkler systems, and any generally confined or generally stagnant water supply contained within a metal containment system that is subject to corrosion.

Effectively water insoluble iterations and methods can be, but are not limited to the following applications.

Some of the compositions useful as oxygen absorbers are not appreciably water soluble. They in fact have a water repellency characteristic. As such, water repellent compositions may be used in applications where moisture is present and it is desirable to have a composition that stays intact and in place when in the presence of moisture.

In one embodiment, the effectively water insoluble compositions useful as oxygen absorbers could be dissolved in a non polar solvent to produce a solution or a paste that could be placed in a confined space wherein oxygen could be sufficiently scavenged and absorbed to prevent or reduce the detrimental effects of oxygen. These water insoluble compositions are effectively water repellent and as such tend to stay intact and in place when in the presence of moisture.

In another embodiment, non polar solutions of the water insoluble compositions could be placed on solid media, and then the non polar solution could be evaporated. This would result in a water repellent composition that stays intact and in place when in the presence of moisture and then could be used in an enclosed environment where it could effectively scavenge or reduce oxygen to provide protection from the detrimental effects of oxygen.

In another embodiment, the water insoluble compositions could be dissolved into non polar solutions and could be placed in separate, other non polar solutions for the purpose of scavenging and absorbing oxygen in order to protect the resultant non polar solutions from the detriment of oxygen.

The following is a list that includes but is not limited to applications of effectively water insoluble compositions: coatings of utensils, devices and or containers; slurries; slurry adhesives; foams; placement in packets or canisters; coating plastic sheets or blankets; and coating the insoluble compositions onto Styrofoam or plastic beads such that they will float on the surface of a liquid.

I claim:

1. A method of absorbing oxygen from an oxygen-containing aqueous solution and or its container comprising contacting the oxygen-containing aqueous solution and or its container with an aqueous solution of the compositions useful as oxygen absorbers that comprise water soluble salts wherein the anion of the salts contains one or more carbon to carbon double bonds and or one or more carbon to carbon triple bonds.

2. The method of claim 1 wherein the anion of the water soluble salts may be derived from the collection that includes but is not limited to all unsaturated fatty acids.

3. The method of claim 1 wherein the cation of the water soluble salts includes, but is not limited to all alkali metals and the ammonium ion (NH₄OH)⁺¹.

4. The method of claim 1 wherein the cation forms a water soluble salt when combined with the anion of claim 1.

5. The method of claim 1 wherein any alkali metal hydroxide or ammonium hydroxide is reacted with any unsaturated fatty acid to form a water soluble salt and then dissolved into an aqueous solution for the propose of absorbing oxygen from the aforementioned aqueous solution and or its container.

6. The method of claim 1 wherein the aqueous solution is any water based food product from the list that includes but is not limited to: stews, milk, milk products, soups, coffee drinks, canned goods, fruit juices, beer, wine, sport drinks, energy drinks, spaghetti sauce, apple sauce, olives, barbeque sauce, teriyaki sauce, canned fish, canned meats, teas, gravies, jams, jellies, preserves, syrups, honey, catsup, mustard, mayonnaise, steak sauce, pickles, relish, aqueous condiments, and in general any aqueous food product kept inside any container.

7. The method of claim 1 wherein the compositions useful as oxygen absorbers are incorporated into moist food substances prior to dehydration in the process of food dehydration such that the compositions useful as oxygen absorbers may preserve the food substances from the deleterious effects of oxygen in the moist state prior to dehydration and the moist state after rehydration.

8. The method of claim 1 wherein the aqueous solution is generally in contact with any substrate within any enclosure wherein the enclosure and or its aqueous solution may be harmed in any way by oxygen that includes situations that include but are not limited to the following: industrial or mechanical equipment, boiler systems, engine cooling systems, steam heating systems, medical or dental equipment, refrigeration or air conditioning equipment, any form of equipment that is heated and or cooled by water, fire sprinkler systems, and any generally confined or generally stagnant water supply contained within a metal containment system that is subject to corrosion.

9. The method of claim 1 wherein the compositions useful as oxygen absorbers are used in a moist, aqueous environment for the purpose of depriving oxygen from aerobic organisms in order to thwart the aforementioned organisms in circumstances such as but not limited to bandaged wounds, fungus treatments, salves, ointments, compresses, and other topical treatments.

10. The method of claim 1 wherein the compositions useful as oxygen absorbers are dissolved into an aqueous solution wherein the resultant solution is used to remove or reduce oxygen from an enclosed space for the purpose of retarding fire within the reaches of the aforementioned enclosed space.

11. A method of absorbing oxygen from an oxygen-containing enclosure that comprises contacting the enclosure and or its contents with compositions useful as oxygen absorbers that comprise water insoluble salts wherein the anion of the salts contains one or more carbon to carbon double bonds and or one or more carbon to carbon triple bonds.

12. The method of claim 11 wherein the water insoluble compositions useful as oxygen absorbers are placed in any enclosure for the purpose of reducing or eliminating oxygen that might otherwise be deleterious to the enclosure and or its contents.

13. The method of claim 11 wherein the water insoluble compositions useful as oxygen absorbers are formed into a contiguous paste and placed in an enclosure for the purpose of reducing or eliminating oxygen that might otherwise have detrimental consequences to the enclosure and or its contents.

14. The method of claim 11 wherein the compositions useful as oxygen absorbers are dried and placed in an enclosed electronics device for the purpose of reducing or eliminating oxygen that might otherwise have detrimental consequences to the electronic device.

15. The method of claim 11 wherein the water repellent nature of the compositions useful as oxygen absorbers enables the compositions useful as oxygen absorbers to withstand contact with moisture in the event that moisture is present in an enclosure that the compositions useful as oxygen absorbers have been placed for the purpose of absorbing oxygen.
